(19) United States
(12) Patent Application Publication
(10) Pub. No.: US 2007/0026200 A1
(43) Pub. Date: Feb. 1, 2007

(54) DECORATIVE MIRROR SIGN

(75) Inventors: Allen E. Garrett, Englewood, OH (US); Ronald L. Abels, Anna, OH (US); Dennis S. Baker, Troy, OH (US); Bruce A. Carpenter, Wapakoneta, OH (US); John L. Finkenbine, North Sidney, OH (US); Jeffery D. Sanford, Sidney, OH (US)

Correspondence Address: RANKIN, HILL, PORTER & CLARK, LLP, 925 EUCLID AVENUE, SUITE 700, CLEVELAND, OH, 44115-1405, US

(73) Assignee: AMERICAN TRIM, L.L.C., Lima, OH (US)

(21) Appl. No.: 11/161,216

(22) Filed: Jul. 27, 2005

(51) Int. Cl. B32B 15/08; B32B 15/20

(52) U.S. Cl. 428/192; 428/457; 428/195.1

(57) ABSTRACT

A decorative sign including an aluminum substrate having a highly reflective surface that is covered, at least in part, by a polymer coating. Inks and/or dyes are transferred into and received by the polymer coating to form a decorative image that covers some, but preferably not all, of the highly reflective surface of the aluminum substrate.

### BACKGROUND OF THE INVENTION

1. Field of Invention.

The present invention is directed a decorative sign, and more particularly, to a decorative mirror sign including an aluminum substrate having a highly reflective surface bearing a decorative image.

2. Description of Related Art.

Decorative mirror signs that bear indicia such as a trademark or other emblematic image are often used to advertise products or in home decoration. Such decorative mirror signs are conventionally made using a mirror formed of silver-coated plate glass. A perimeter border or other decoration is often applied to the glass surface of the mirror using a screen-printing technique or the like. The decorated glass mirror is often received in a wooden frame or other protective structure.

Conventional decorative glass mirror signs are relatively expensive to manufacture. Plate glass and silver are expensive materials, and the silvering process entails many processing steps in order to produce a finished product. Because plate glass is a very fragile material, the scrap rate tends to be quite high during the manufacturing process. Furthermore, the finished product remains prone to breakage during packaging, distribution and installation by end-users. Broken glass presents a safety hazard for manufacturing workers, end-users and waste handlers.

As noted above, conventional decorative mirror signs often include a decorative border and/or other indicia applied to the exposed glass surface of the mirror. Such decorative indicia are conventionally applied using silk-screening techniques, lithographic processes, etching, embossing and/or by application of colored foils or acrylic layers. In most of these processes, in order to produce multi-colored indicia it is necessary to apply several layers of different colored inks, allowing sufficient drying time between each layer application. This is a very time-consuming and labor-intensive process, and adds considerably to the cost of manufacturing conventional decorative glass mirrors. In addition to the cost, the resulting image generated through the use of such processes can appear distorted due to irregularities in the indicia layer or the glass surface.

### SUMMARY OF THE INVENTION

The present invention overcomes and resolves many of the difficulties and drawbacks associated with the production, distribution and end-use of conventional decorative glass mirror signs. A decorative mirror sign according to the invention comprises an aluminum substrate having a highly reflective surface that is covered, at least in part, by a polymer coating. Inks and/or dyes are transferred into and received by the polymer coating to form a decorative image that covers some, but preferably not all, of the highly reflective surface of the aluminum substrate. Thus, the present invention provides a decorative mirror sign having a high quality reflective mirror surface that is relatively lightweight and shatterproof, and a method for the rapid and waste-free production of decorative signs.

The foregoing and other features of the invention are hereinafter more fully described and particularly pointed out in the claims, the following description setting forth in detail certain illustrative embodiments of the invention, these being indicative, however, of but a few of the various ways in which the principles of the present invention may be employed.

### BRIEF DESCRIPTION OF THE DRAWINGS

FIG. 1 is a schematic perspective view depicting an exemplary decorative mirror sign according to the present invention.

FIG. 2A is an edge-on schematic view depicting another embodiment of a decorative mirror sign according to the invention.

FIG. 2B is an edge-on schematic view depicting the arrangement of various elements used in the method of the invention.

FIG. 3 is an edge-on schematic view depicting an embodiment of a decorative mirror sign according to the invention bearing lighting elements.

FIGS. 4A and 4B are edge-on schematic views depicting alternative lighting element configurations in accordance with the invention.

FIG. 5 is an edge-on schematic view depicting another embodiment of a decorative mirror sign according to the invention.

### DETAILED DESCRIPTION OF THE INVENTION

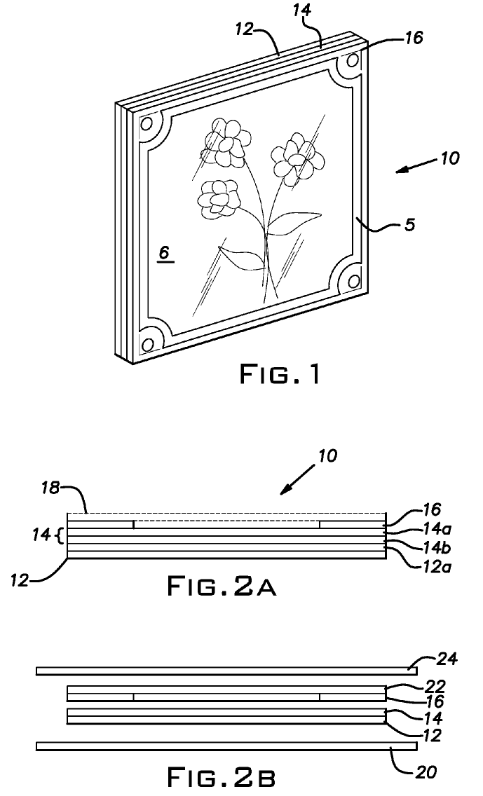

Reference will now be made to the accompanying drawing figures, where it is appreciated that like reference numerals refer to like elements. FIGS. 1 and 2A show a decorative mirror sign 10. The decorative mirror sign 10 comprises an aluminum substrate 12 having a highly reflective surface. Throughout the instant specification and in the appended claims, “a highly reflective surface” refers to and means a surface exhibiting a specular reflectivity of at least 70% in the light range of 800-1900 nm measured using a zero degree (0°) angle of incidence between the source of light and the surface. The highly reflective surface of the aluminum substrate 12 is covered, at least in part, by a substantially transparent polymer coating 14 that forms a protective layer on the highly reflective surface of the aluminum substrate 12. Inks and/or dyes 16 are transferred into and received by at least a portion of the polymer coating 14 applied to aluminum substrate 12 to form an image that covers a portion of the highly reflective surface of the aluminum substrate 12. In this manner, a decorative mirror sign 10 according to the invention is formed.

In the presently preferred embodiment of the invention, the aluminum substrate 12 comprises a sheet of 1085 aluminum alloy having a temper of H19 and a thickness of about 0.025 inches. At least one side of the aluminum substrate 12 is provided with a highly reflective surface. Aluminum substrates having a highly reflective surface can be obtained from Lorin Industries of Muskegon, Mich. It will be appreciated that the alloy, thickness, temper and other physical properties of the aluminum substrate 12 are not critical, and can be varied depending upon the particular application in which the decorated mirror sign 10 is to be used, all without departing from the invention.

A highly reflective surface can be provided on an aluminum substrate using a “bright dip” chemical process that removes surface imperfections. In this way, a bright, lustrous highly reflective finish can be formed on at least one side of the aluminum substrate 12. As noted above, a highly reflective surface exhibits a specular reflectivity of at least 70% in the light range of 800-1900 nm measured using a zero degree (0°) angle of incidence between the source of light and the surface. More preferably the highly reflective surface exhibits a specular reflectivity of at least about 80%, and more preferably of at least about 85%, in the light range of 800-1900 nm measured using a zero degree (0°) angle of incidence between the source of light and the surface.

As schematically illustrated in FIG. 2A, the highly reflective surface of the aluminum substrate 12 is preferably provided with an anodized layer 12a that protects the highly reflective surface. The anodized layer 12a comprises a transparent layer or film of aluminum oxide that retards further oxidation of the underlying aluminum. Also, the anodized layer 12a is harder than the underlying aluminum, and thereby prevents the highly reflective surface from scratching and other damage. Although an anodized surface 12a is preferred, it will be appreciated that the highly reflective surface of the aluminum substrate 12 need not be anodized prior to the application of a polymer coating 14.

As schematically illustrated in FIGS. 1 and 2A, the polymer coating 14 preferably comprises one or more polymer coats or layers that are applied to and cover at least a portion of the (anodized and/or non-anodized) highly reflective surface of the aluminum substrate 12. In the presently most preferred embodiment of the invention, the polymer coating 14 comprises a single layer. However, in the alternate embodiment schematically illustrated in FIG. 2A, the polymer coating 14 comprises a base coat layer 14a that is applied to the highly reflective surface of the aluminum substrate 12 and a top coat layer 14b that is applied over the base coat layer 14a. Base coat 14a is preferably applied at a thickness of about 0.0006 inches, and top coat 14b is preferably applied at a thickness of at least about 0.0007 inches to about 0.0008 inches.

The polymer coating 14 should readily adhere to the highly reflective surface of the aluminum substrate 12, should be substantially transparent such that the optical clarity and reflectivity of the highly reflective surface of the aluminum substrate is not adversely degraded, should be durable and should be capable of receiving transfer printed inks and/or dyes. In view of these requirements, thermosetting polymers such as polyesters, acrylics, epoxies and fluoropolymers, are preferred for use in forming the polymer coating 14. Polymer coating materials suitable for use in the present invention include a fluoropolymer coating sold by PPG Industries of Pittsburgh, Pa. under the trademark MEGAFLON and a polyester coating sold by PPG under the trade designation APTC-4810.

As noted, the polymer coating 14 (or 14a and 14b) is preferably substantially transparent such that it does not screen the highly reflective surface of the aluminum substrate or interfere with visibility of the inks or dyes that are diffused into the polymer coating. However, a base coat 14a comprising a pigment (e.g., a white pigment such as TiO₂) can optionally be provided over a portion of the highly reflective surface of the aluminum substrate such that the inks or dyes transferred into an overlying top coat 14a may be contrasted from the non-decorated portions of the highly reflective surface.

The layer or layers comprising the polymer coating 14 are preferably applied via roll coating means. However, the polymer coating can alternatively be applied using a screen printing process, using spraying techniques or by other conventional coating processes. When two or more layers are applied, it is preferable that each coating layer be cured before the next layer is applied. Polyester coatings can be cured at a temperature of from about 350-450° F., and more preferably at a temperature of about 410° F. for about 20-40 seconds, and more preferably about 30 seconds.

It will be appreciated that multiple polymer coating layers can be applied, and that some of the layers may be pigmented (e.g., white) to provide contrast for the inks and/or dyes transferred into and received by the polymer coating. The order of such layers is not per se critical. Fore example, one or more pigmented base coat(s) and one or more transparent top coat(s) can be used, or one or more transparent base coat(s) and one or more pigmented top coat(s) can be used. Alternatively, pigmented or transparent intermediate coat(s) can be applied between the base coat(s) and top coat(s). Any combination of layers can be used without departing from the invention.

In one embodiment of the invention, inks and/or dyes are transferred into the polymer coating 14 covering a perimeter portion 5 of the aluminum substrate 12 so as to create a decorative border that frames a non-decorated or partially decorated central portion 6, which allows the decorative mirror sign 10 to be used as a conventional mirror. It will be appreciated that inks and/or dyes can be transferred into and received by the polymer coating 14 in an infinite variety of configurations to create desired indicia provided at least a portion of the highly reflective surface of the aluminum substrate is left uncovered and substantially unobstructed or only partially covered. It is possible to transfer the inks and/or dyes into the polymer coating to create decorative images having a three-dimensional appearance or a multi-dimensional appearance.

The inks and/or dyes are preferably transferred to the polymer coating 14 using a transfer printing technique such as sublimation printing. In the sublimation printing process, dyes and/or inks are printed onto a paper carrier sheet as a reverse image, then the carrier paper is placed onto the polymer coated aluminum substrate such that the inks and/or dyes are positioned adjacent to or in contact with the polymer coating 14. The carrier paper is pressed into contact with the polymer coated aluminum substrate using heat and pressure, causing the inks to transfer from the carrier paper and diffuse into the polymer coating. The sublimation printing process is disclosed, for example, in U.S. Pat. No. 5,856,267, assigned to the present assignee (American Trim, L.L.C.), the disclosure of which is hereby incorporated by reference.

In other transfer printing techniques, the inks and/or dyes to not fully diffuse or sublimate into the polymer coating, but rather they form an image layer 16 on the surface of the polymer coating 14. Image layer 16 is shown in the accompanying figures as a separate layer, but depending upon the type of transfer printing process used, a separate layer may or may not actually be formed. Accordingly, the schematic drawing figures should be understood as merely being illustrative of the process and materials, and should not be considered limiting.

Decorative mirror signs 10 made according to the present invention can be formed that exhibit images having a three-dimensional, semi-reflective appearance similar to those applied to glass mirrors by conventional processes. However, because the inks and/or dyes used to form the images are diffused into the polymer coating, such images do not include the distortion created by the thickness of the glass between the applied decorative image and the reflective silver layer.

In a particular embodiment schematically illustrated in FIG. 5, an aluminum substrate 12 having a highly reflective surface is provided. A first clear coat layer 14a of APTC-4810 polyester coating is applied to the highly reflective surface of the aluminum substrate 12. A white pigmented polyester intermediate coating layer 15 is selectively screened at a thickness of about 0.0007 inches to about 0.0008 inches onto the first clear coat layer 14a to cover portions of the aluminum substrate 12 where an image is to be applied. A second clear coat layer 14b of APTC-4810 polyester coating is then applied to cover the white pigmented polyester intermediate coating layer 15. Inks and/or dyes are then sublimation printed onto the clear coat layer 14b The sublimated image layer 16 is applied onto the second clear coat layer 14b. Any one of a number of white coating materials may be used for layer 15, however, one suitable coating is polyester white available from PPG under the trade designation 3MW79322.

It will be appreciated that additional optional protective clear coat layers can be applied over the decorated surface of the decorative mirror sign 10 after the inks and/or dyes have been applied. Such protective layers can include ultraviolet light protective materials that prevent the inks and/or dyes from fading and the underlying polymer coatings from degradation due to exposure to ambient ultraviolet light. As with all the other layers disclosed herein, it is understood that this layer can be applied by rolling, screening, spraying, or any other coating application process.

FIG. 2B schematically illustrates a method for manufacturing a decorative mirror sign 10 according to the invention. A base or bottom platen 20 is provided that supports an aluminum substrate 12 having a highly reflective surface coated with a polymer coating 14. A carrier sheet 22 having inks and/or dyes 16 applied in the form of a reverse image is placed such that the inks and/or dyes are adjacent to or in contact with the polymer coating 14. A top platen 24 is used to press the carrier sheet 22 against the polymer coating 14 disposed on the aluminum substrate 12. Heat and pressure cause the inks and/or dyes to transfer from the carrier sheet 22 and diffuse into the polymer coating 14.

The bottom platen 20 preferably includes a layer of rubber such as silicone and a felt mat thereon for distributing the pressing force against the metal sheet. The rubber layer may be about ½ inch thick and the felt layer may be about ¼-½ inch thick, and may comprise one, two or more layers of felt.

The top platen 24 preferably has a protective layer or sheet formed of a non-stick material such as polytetrafluoroethylene (“PTFE”) or other fluorocarbon polymer on its bottom surface to protect the surface of the platen and provide a slightly resilient surface to apply pressure uniformly against the carrier sheet 22 and the aluminum substrate 12 supported by the bottom platen 20. Alternatively, the protective layer may also be a cotton sheet, or any other conventional type of sheet. The bottom surface of the top platen 24 must be flat and polished in order to prevent imprinting imperfections into the polymer coating on the aluminum substrate 12. The fluorocarbon polymer sheet protects the polished surface of the platen 24 and evenly distributes the transfer pressure without interfering with heat transfer. The polymer sheet is preferably relatively thin, with a thickness of about 0.020 to 0.030 inch.

The top platen 24 is preferably provided with heating means such as electrical heating rods or coils (not shown) for heating the carrier paper 22 and the aluminum substrate 12. Alternatively, the bottom platen 20 or both the bottom platen 20 and top platen 24 can be provided with means for heating the aluminum substrate and carrier paper. In a preferred embodiment, the bottom platen 20 is vertically movable and the top platen 24 is a fixed construction. The bottom platen 20 can be moved vertically using mechanical means or through the use of an air bag or bags, which are inflated to lift the bottom platen 20 upwardly and press the aluminum substrate 12 and carrier paper 22 into the fixed top platen 24, and deflated to lower the bottom platen and allow for removal of the decorated mirror sign 10.

In one preferred embodiment, the carrier paper 22 and polymer coated aluminum substrate 12 are pressed between the top platen 24 and bottom platen 20, which at least one of which is heated to a temperature of about 350-425 ° F., under a pressure of approximately 50-80 pounds per square inch (psi). The pressure is maintained until the peak temperature of the aluminum substrate 12 reaches about 350-370 ° F. It will be appreciated that temperatures, pressures and press times can be adjusted without departing from the invention.

The carrier sheet 22 is pressed into contact with the aluminum substrate 12 under heat and pressure for a typical cycle time of about 10-120 seconds depending on a variety of factors such as the ink and/or dye colors, the composition and quantity of inks and/or dyes to be transferred, the composition of the polymer coating, and temperature and pressure employed, and the thickness of the aluminum substrate.

In a preferred embodiment of the invention, the aluminum substrate 12 and the carrier paper 22 are provided with at least two holes (not shown) through which receiving pins (not shown) extending upwardly from the bottom platen 20 pass. The holes and pins assure that the aluminum substrate 12 and carrier paper 22 are properly aligned and registered before pressing occurs. At least one of the receiving pins extending upwardly from the bottom platen 20 is preferably movable in a direction perpendicular to its vertical axis to accommodate expansion of the aluminum substrate 12 as it is heated during transfer printing. The holes in the aluminum substrate 12 are preferably formed in portions of the aluminum substrate (e.g., the marginal edges) that will be covered by framing and thus will not be seen or that will be trimmed off to form the finished product. In another preferred method, the carrier paper 22 is provided with guide marks that help an operator to align the carrier paper 22 on the aluminum substrate before pressing. If necessary, the operator can tape the carrier paper 22 to the aluminum substrate prior to pressing to fix the carrier paper 22 on the desired location. Fluorocarbon polymer adhesive tape can be used for this purpose.

It will be appreciated that the present method is scalable, and that a plurality of aluminum substrates can be transfer printed simultaneously using large bottom and top platens 20, 24. Presses can be obtained from the George Knight Company or Aztec Press that are large enough to simultaneously transfer print four polymer coated aluminum substrates having a dimension of 11- 1/2 inches by 28 inches. Four polymer coated aluminum substrates 12 can be positioned side by side on pins extending upwardly from the bottom platen 20, and four carrier paper 22 sheets can be positioned on the aluminum substrates 12. It is important that after pressing, the carrier paper 22 be separated from the aluminum substrate 12 very soon after the press is opened to minimize possible “ghosting” of the image on the aluminum substrate 12.

In a preferred mode of operation, a relatively small amount of adhesive is applied to the top surface of the carrier paper (not the ink or dye bearing surface) to temporarily adhere the carrier paper to the top platen 24 when the press is opened after completion of printing. The adhesive may, for example, be diluted aqueous solution of a polyvinyl alcohol (“PVA”) based glue such as is sold by Borden, Inc. under the ELMER'S GLUE trademark. The PVA glue may be diluted to about 50:50 by weight with water. Use of an adhesive composition allows the carrier paper 22 to temporarily adhere to the top platen 24 when the press is opened, thereby protecting the aluminum substrate 12 from ghosting or other imprinting defects, which is promptly removed before the carrier paper 22 is removed. The carrier paper 22 will then fall off of or can be easily pulled from the top platen 24 within a few seconds after opening of the press and discarded.

The process of this invention is especially well adapted for producing a decorated mirror sign. Conventional decorated glass mirror signs are often used to advertise beer and other products. A decorated mirror sign according to the present invention is particularly suitable for this purpose, and provides distinct advantages. For example, a decorated mirror sign according to the invention is shatterproof and more lightweight than conventional decorated glass mirror signs. A decorated mirror sign according to the invention provides similar reflective properties as a decorated glass mirror sign, but without the associated costs and risks of glass.

However, having provided a detailed description of preferred embodiments for practicing the invention, it will be apparent to those skilled in the art that numerous modifications can be made in such embodiments without departing from the invention or the scope of the claims appended hereto. For example, the polymer coated aluminum substrate can be preheated before it is placed between the transfer printing platens. A further alternative includes moving the top platen rather than the bottom platen to open and close the press for transfer printing. Vacuum means can be used in place of an adhesive solution to temporarily retain the carrier paper on the upper platen when the press is opened after transfer printing. Other alternatives falling within the scope of the method will be apparent to those skilled in the art.

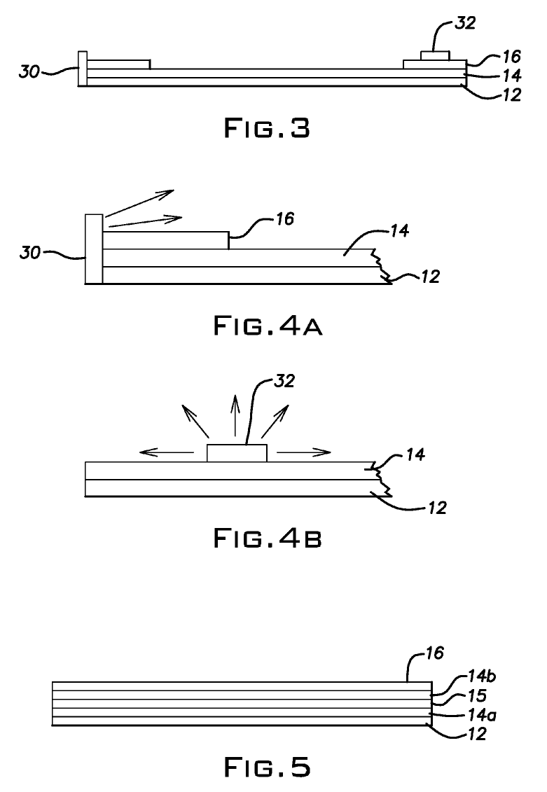

FIGS. 3, 4A and 4B schematically depict a further embodiment of the invention wherein one or more illumination sources are incorporated into the decorative mirror sign. As especially shown in FIG. 4A, these illumination sources can include an edge-mounted source 30 incorporated into a portion or an entirety of a perimeter edge of the decorative mirror sign 10. Alternatively, as shown in FIG. 4B, the illumination sources can include a surface-mounted source 32 incorporated onto a surface portion of the decorative mirror sign 10.

In the preferred embodiment, the illumination source comprises light emitting diodes and/or electroluminescent elements, which can be applied via screen printing techniques. In many applications, it is preferable for the illumination source to be mounted on or adjacent to an edge of the decorative mirror sign 10 such that the emitted light shines parallel to the surface of the decorative mirror sign, thereby providing a subtle lighting effect that highlights the image printed on the surface of the decorated mirror sign.

In another aspect of the invention, one or both of the illumination sources 30, 32 can be sources of ultraviolet radiation. A portion or the entirety of the decorative image 16 can include a pigment that fluoresces under the emitted ultraviolet radiation, so as to provide a brightly-colored fluorescent light effect in the decorative image 16. In another aspect of the invention, it is contemplated that LED material could be deposited directly on the surface of the sign or provide localized areas of light emission that are incorporated into the decorative pattern of the decorative image 16.

By using an aluminum substrate having a highly reflective surface as a mirror instead of a silver-coated glass sheet, substantial advantages are realized in terms of a reduction in waste and in weight/freight costs. In addition, the use of transfer printing allows for the creation of complex images without incurring numerous process steps.

Additional advantages and modifications will readily occur to those skilled in the art. Therefore, the invention in its broader aspects is not limited to the specific details and illustrative examples shown and described herein. Accordingly, various modifications may be made without departing from the spirit or scope of the general inventive concept as defined by the appended claims and their equivalents.

What is claimed is:

1. A process for manufacturing a decorative mirror sign comprising:
providing an aluminum substrate having a highly reflective surface;
covering at least a portion of the highly reflective surface with a polymer coating; and
transferring an ink and/or a dye to the polymer coating to form a decorative image, wherein at least a portion of the aluminum substrate remains highly reflective after the decorative image is formed.

2. The process according to claim 1 wherein the highly reflective surface of the aluminum substrate is anodized.

3. The process according to claim 1 wherein covering step comprises coating the highly reflective surface of the aluminum substrate with a pigmented polymer base coat, and coating the base coat with a transparent top coat.

4. The process according to claim 1 wherein the transferring step comprises:
providing a carrier paper bearing the ink and/or dye in the form of a reverse-image of the decorative image;
positioning the carrier paper such that the reverse-image is adjacent to or in contact with the polymer coating on the highly reflective surface of the aluminum substrate; and
pressing the carrier paper and aluminum substrate together using heat and pressure to transfer the reverse-image of the decorative image to the polymer coating.

5. The process according to claim 1 wherein the decorative image is formed on a perimeter portion of the aluminum substrate.

6. The process according to claim 1 further comprising incorporating at least one illumination source into the decorative mirror sign.

7. The process according to claim 6 wherein the incorporating step comprises forming an ilumination source on an edge portion and/or a surface portion of the decorative mirror sign.

8. The process according to claim 6 wherein the illumination source is a light emitting diode or an electroluminescent element.

9. The process according to claim 6 wherein the illumination source emits ultraviolet radiation and wherein at least one of the ink and/or dye applied to form the decorative image comprises a pigment that fluoresces under the ultraviolet radiation.

10. A decorative sign comprising:
an aluminum substrate having a highly reflective surface;
a polymer coating covering at least a portion of the highly reflective surface of the aluminum substrate; and
a decorative image transferred to at least a portion of the polymer coating.

11. The decorative sign according to claim 10 the highly reflective surface of the aluminum substrate is anodized.

12. The decorative sign according to claim 10 wherein the polymer coating comprises a pigmented polymer base coat applied to the highly reflective surface of the aluminum substrate, and a transparent top coat applied to the base coat.

13. The decorative sign according to claim 10 wherein the decorative image is formed on a perimeter portion of the aluminum substrate.

14. The decorative sign according to claim 10 further comprising at least one illumination source.

15. The decorative sign according to claim 14 wherein the illumination source is incorporated into an edge portion of the decorative mirror sign and/or a surface portion of the decorative mirror sign.

16. The decorative sign according to claim 14 wherein the illumination source is a light emitting diode or an electroluminescent element.

17. The decorative sign according to claim 14 wherein the illumination source emits ultraviolet radiation and wherein at least a portion of the decorative image comprises a pigment that fluoresces under the ultraviolet radiation.

18. The decorative sign according to claim 10 further comprising an ultraviolet radiation protective clear cover coat layer applied over the exposed surface of the decorative mirror.

19. The decorative sign according to claim 10 wherein said reflective aluminum has a reflectance of at least 70% measured at 0° incidence in the light range of 800 to 1900 nm.

20. The decorative sign according to claim 10 wherein at least a portion of said polymer coating is a transparent clear coating such that at least a portion of said aluminum substrate remains highly reflective.
